(19) United States
(12) Patent Application Publication
(10) Pub. No.: US 2008/0283507 A1
(43) Pub. Date: Nov. 20, 2008

(54) PLASMA TREATMENT APPARATUS AND METHOD OF PLASMA TREATMENT

(75) Inventors: Hideo Kitagawa, Tottori-shi (JP); Yusuke Fukuchi, Atsugi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/117,612

(22) Filed: May 8, 2008

(30) Foreign Application Priority Data
May 16, 2007 (JP) 2007-131088

(51) Int. Cl. B23K 9/00

(52) U.S. Cl. 219/121.36

(57) ABSTRACT

A plasma treatment apparatus and a method of plasma treatment for reducing generation of Na atoms in the case where a silica glass and the like are used for a member made of dielectric material are provided. The provided plasma treatment apparatus includes a dielectric member having an impurity element forming positive and movable ions, a vacuum chamber partially sealed with the dielectric member, and a radiator radiating electromagnetic wave into the vacuum chamber through the dielectric member to generate plasma in the vacuum chamber and to treat a workpiece using the plasma. The apparatus further includes an electrode on the dielectric member on a surface opposite the surface exposed to the plasma. The generation of Na can be reduced by applying to the plasma a negative DC potential which is lower than a floating potential measured at the surface of the dielectric member exposed to the plasma.

### BACKGROUND OF THE INVENTION

1. Field of the Invention

The present invention relates to a plasma treatment apparatus including a silica glass member and being capable of reducing an amount of impurities released from the silica glass member and relates to a method of plasma treatment.

2. Description of the Related Art

Recently, MOSFETs have been required to have high performance in accordance with a reduction of a design rule for LSIs. In particular, battery-driven mobile terminal apparatuses such as mobile phones are required to reduce current leakage through a gate dielectric film or the leakage between source and drain electrodes as far as possible from a standpoint of low power consumption as well as high communication speed. Also in CCD or CMOS type sensors used in digital imaging apparatuses, the use of which has increased in recent years, the current leakage has been controlled in order to suppress dark current.

Among several factors such as plasma damage causing an increase in current leakage, one of the main factor is contamination with impurities. Since semiconductor manufacturing equipment is composed of many parts made of metal, there is a very high probability that atoms of heavy metals such as Fe, Ni, and Cr are incorporated as impurities.

Among many impurity elements, alkali metals such as Na and K are the most difficult to control. In particular, Na exists not only in the natural environment in large amounts but also in perspiration secreted from human bodies. Therefore, in semiconductor factories, much attention is given to Na contamination. Here, silica glass can be formed into materials including silicon and oxygen with very high purity and the amount of impurities therein can be reduced to an amount in the order of ppm or less.

TABLE 1
(Units: ppm)

| | |
|---|---|
| Al | 10-20 |
| Fe | 0.2-0.8 |
| Cu | 0.01-0.1 |
| Ti | 1.0-1.5 |
| Li | 0.1-1.5 |
| Na | 0.3-1.0 |
| K | 0.3-1.0 |
| Ca | 0.4-0.8 |
| B | <0.1 |
| P | <0.2 |
| OH | 5-200 |

Table 1 shows a typical value of impurity concentration in silica glass. It is found that Al and OH are present in large amounts and other impurity elements are present at a concentration of about 1 ppm or lower. Therefore, semiconductor manufacturing equipment, which performs a process having a high probability of metal contamination, usually possesses a container made of silica glass or covered with silica glass on the inner surface thereof. Furthermore, since silica glass is mechanically strong and has resistance to heat, silica glass can be used in a wide range of applications, for example, for a tube of a furnace for heat treatment or a window of vacuum equipment.

Although silica glass has excellent properties as mentioned above, silica glass also has disadvantageous properties. That is, atoms of an alkali metal such as Na easily diffuse in silica glass and are incorporated therein.

In silica glass, Na atoms are ionized and exist as Na+ ions. The Na+ ions, which are called “mobile ions,” diffuse at a high speed in the silica glass by heat or an electric field. Therefore, even if a highly purified raw material which was purified with much attention to a high degree is provided, Na atoms in the ambient area are undesirably incorporated into the silica glass during any or all of the steps of processing the silica glass into a member, handling the silica glass, and installing the silica glass in the equipment. Actually the resulting members contain Na atoms at a concentration of as high as several ppm.

TABLE 2

| Step | Na concentration |
|---|---|
| polishing of matrix surface | 0.1 ppm |
| grinding | 0.1 ppm |
| annealing | 1.0 ppm |

Table 2 shows that the concentration of Na in the silica glass increased with each manufacturing step. The values of the concentration of Na listed in Table 2 were obtained by dissolving all samples having a size of 10 mm×10 mm×3 mm into hydrofluoric acid, measuring the Na concentration of the hydrofluoric acid, and calculating the average value of concentration. Although the concentration of Na in the raw silica glass of the present experiment was as low as 0.1 ppm, it was increased tenfold due to Na contamination occurring in an annealing step after mechanical treatment.

As mentioned above, it was found that a relatively large amount of Na is incorporated into the silica glass during the manufacturing steps. Furthermore, Na atoms are gradually accumulated in a member made of the silica glass by contamination caused by installing and handling the member into the equipment, introducing wafers and gases into the equipment after installation of the member. If the temperature of the silica glass becomes high or the silica glass is exposed to the plasma, the accumulated Na atoms are released outside the silica glass. This leads to wafers being contaminated. Fluctuation of Na concentration uncontrollably occurring in factories leads to instability of the properties of products.

Regarding the method for purifying silica glass, Japanese Patent Publication No. 7-84327 discloses a method using heat and an electric field. By using the existing method, silica glass having a low concentration of Na can be obtained.

However, taking into account that silica glass undergoes a mechanical treatment or an annealing treatment before being installed in equipment, since Na atoms are incorporated into the silica glass at an order of ppm in a manufacturing step, which is clearly understood by the findings provided by the inventor of the present invention, it is ineffective to prepare very highly purified material. By consideration of the method described in Japanese Patent Publication No. 7-84327, a method including the steps of applying heat and an electric field to the manufactured member so as to move Na atoms therein towards one end thereof and then remove the Na-enriched layer by a mechanical treatment or an etching treatment using an agent can be easily developed. In the highly purified silica glass obtained through the above-mentioned methods, however, Na atoms are gradually accumulated with a long-term use thereof in a manufacturing apparatus.

One of treatments for contaminated silica glass is conducted by removing a contaminated surface layer using an etching method with hydrofluoric acid as described in Japanese Patent Laid-Open No. 2006-4985. Absorption and release of Na atoms from silica glass by a heat treatment can be understood according to a diffusion theory. However, the mechanism of the release of Na atoms from the silica glass exposed to plasma cannot be understood according to the diffusion theory alone. A factor causing the release of Na atoms may be a local temperature rise by incident ions or a sputtering of a surface of the silica glass. The above phenomenon, however, occurs within a depth of as small as several nanometers to several tens of nanometers from the surface of the silica glass.

In the precision experiment conducted by the inventor of the present invention, when silica glass serving as a window for transmitting electromagnetic waves, that is, an electromagnetic wave transmitting window, is exposed to plasma for a long period, the amount of Na atoms released from the surface of the window was inexplicably large. That is, the release of Na atoms from silica glass caused by plasma may be caused by a mechanism which is completely different from the known mechanisms based on the reaction of the local portion of the silica glass to the plasma. The detail mechanism, however, has yet to be elucidated. As mentioned above, in manufactured silica glass, impurities of Na atoms are present in the order of several ppm.

It is found that Na atoms are continuously released from silica glass, over a long term, which is used as an electromagnetic wave transmitting window fixed on a plasma treatment apparatus. However, the total amount of Na atoms released cannot be explained by Na contamination of the surface of the silica glass alone, and the mechanism behind this has yet to be elucidated. Therefore, contrary to the requirement that contamination caused by Na atoms released from silica glass should be lowered as much as possible, the contamination could not have been controlled.

### SUMMARY OF THE INVENTION

The present invention provides a plasma treatment apparatus and a method of plasma treatment for reducing generation of Na atoms in the case that silica glass and the like are used for a member made of a dielectric material.

The plasma treatment apparatus of the present invention includes a dielectric member having an impurity element forming positive and movable ions, a vacuum chamber partially sealed with the dielectric member, a pressure controller introducing gas into the vacuum chamber and controlling a pressure in the vacuum chamber, an electromagnetic wave radiator radiating electromagnetic waves into the vacuum chamber through the dielectric member, and a workpiece holder. The plasma treatment apparatus of the present invention generates plasma in a vacuum chamber and treats a workpiece with the generated plasma. The plasma treatment apparatus of the present invention further includes an electrode provided on the dielectric member at a surface opposite the surface exposed to the plasma and a DC potential applier, which applies to the electrode a negative DC potential which is lower than a floating potential at the surface of the dielectric member exposed to the plasma.

According to the present invention, in a plasma treatment apparatus using a silica glass and the like for a window formed of a dielectric member for transmitting electromagnetic waves, an electrode is provided on the silica glass member at a side of a silica glass member opposite the surface exposed to the plasma. Furthermore, a negative DC potential, which is lower than a floating potential measured at the surface of the dielectric member exposed to the plasma, is applied to the electrode so that generation of Na atoms can be suppressed.

Further features and aspects of the present invention will become apparent from the following description of exemplary embodiments with reference to the attached drawings.

### BRIEF DESCRIPTION OF THE DRAWINGS

FIG. 1 is a block diagram of an example plasma treatment apparatus according to an embodiment of the present invention.

FIG. 2 is a plan view illustrating a positional relationship of a silica glass window, a negative potential applying electrode, and slot antennas of the plasma treatment apparatus according to the embodiment of the present invention.

FIGS. 3A and 3B are schematic views showing an electric potential distribution in a plasma treatment apparatus of the embodiment of the present invention, and illustrate the principal of a phenomenon in which Na atoms are released from the silica glass window exposed to the plasma.

FIG. 4 is a graph showing the relationship between electronic temperature Te and sheath potential under the assumption that an ion species of the plasma is N+.

FIG. 5 is a graph showing the distribution of Na concentration in the depth direction in silica glass members, in which one member is measured immediately after fabrication and the other member is measured after being used for 100 hours.

FIG. 6 is a graph showing Na concentrations measured at a surface of wafers of the embodiment of the present invention.

FIG. 7 is a block diagram of an example surface-wave interference plasma treatment apparatus according to a modified example of an embodiment shown in FIG. 1 of the present invention.

FIG. 8 is a block diagram of an example of an inductive coupled plasma treatment apparatus according to an embodiment of the present invention.

FIG. 9 is a block diagram of a plasma treatment apparatus according to an embodiment of the present invention, the plasma treatment apparatus having a coaxial line connected with an electromagnetic radiation antenna.

FIG. 10 is a diagram of an existing plasma treatment apparatus.

### DESCRIPTION OF THE EMBODIMENTS

Various embodiments, features and aspects of the present invention will now herein be described with reference to attached drawings.

### First Exemplary Embodiment

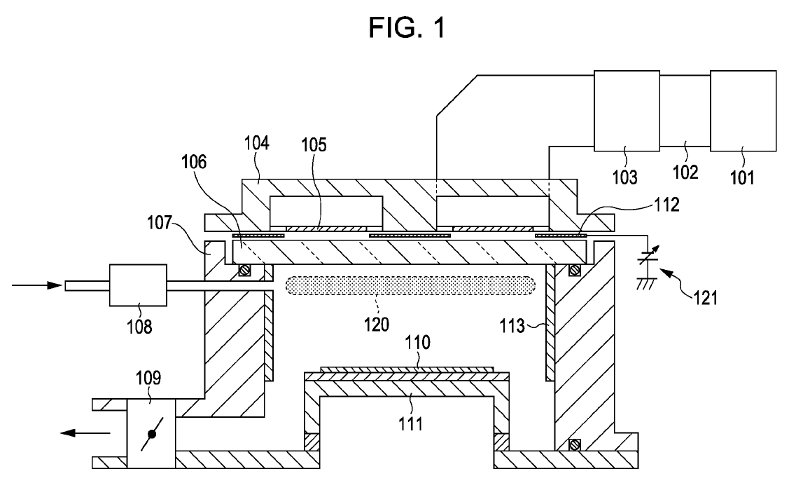

A plasma treatment apparatus and a method of plasma treatment according to an embodiment of the present invention are described with reference to FIG. 1.

The plasma treatment apparatus of the present embodiment includes a dielectric window 106 made of silica glass of a dielectric member, having an impurity element forming positive and movable ions, a vacuum chamber 107 partially sealed with the dielectric member, a mass flow controller 108 and a conductance control valve 109, which serve as pressure controllers introducing gas into the vacuum chamber 107 and controlling a pressure in the vacuum chamber 107, a slot antenna 105 serving as an electromagnetic wave radiator radiating electromagnetic waves into the vacuum chamber 107 through the dielectric window 106, which is made of silica glass of the dielectric member, a wafer stage 111 serving as a holder which holds a wafer as a workpiece. The plasma treatment apparatus generates plasma 120 in the vacuum chamber 107 and treats the wafer of workpiece with the plasma 120. The plasma treatment apparatus of the present invention further includes a negative potential applying electrode 112 provided on a surface of the dielectric window 106 opposite to the surface exposed to the plasma 120 and a DC power supply 121 serving as a DC potential applier which applies to the negative potential applying electrode 112 a negative DC potential which is lower than a floating potential measured at the surface of the dielectric window 106 exposed to the plasma 120. The impurity element can be an alkali metal, an alkaline-earth metal, or hydrogen.

The dielectric member can be a sintered body made of silica glass, aluminum nitride, aluminum oxide, silicon nitride, silicon carbide, or a mixture thereof. Furthermore, the negative DC potential can be a potential in which high frequency waves are superposed and has a time average negative potential. Furthermore, the electromagnetic wave radiator can form an induced electromagnetic field using a coil or an electromagnetic induction. Furthermore, an opening formed on a face of a waveguide or a cavity resonator can serve as the electromagnetic wave radiator. Furthermore, the electromagnetic wave radiator can be an electromagnetic radiation plate connected with a coaxial line. Furthermore, the electrode to which the negative DC potential is applied can serve as the electromagnetic wave radiator radiating electromagnetic wave into the vacuum chamber 107. Furthermore, the electrode to which the negative DC potential is applied can be provided separately from the electromagnetic wave radiator radiating electromagnetic waves into the vacuum chamber 107.

The plasma treatment apparatus of the present embodiment includes a high-frequency oscillator 101, a waveguide 102, a matching unit 103, a circular waveguide 104, a slot antenna 105, the dielectric window 106 made of silica glass, and the vacuum chamber 107. The plasma treatment apparatus of the present embodiment further includes the mass flow controller 108, the conductance control valve 109, a silicon wafer 110, the wafer stage 111, and the negative potential applying electrode 112.

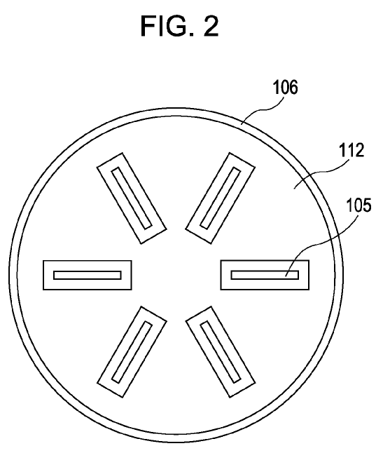

FIG. 2 is a view illustrating a positional relationship of the negative potential applying electrode 112, the slot antenna 105, and the dielectric window 106 made of silica glass.

First, the silicon wafer 110 is placed on the wafer stage 111 kept at a predetermined temperature. Then the pressure inside the vacuum chamber 107 is decreased to a pressure of about 0.1 Pa by an evacuator (not shown in drawings). Next, gas is introduced into the evacuated vacuum chamber 107 using the mass flow controller 108 and the pressure inside the chamber is controlled to be the predetermined value by adjusting the conductance control valve 109 while measuring the pressure using a Baratron gauge (not shown in drawings). Next, microwaves of 2.45 GHz are irradiated towards the inside of the vacuum chamber 107 through the dielectric window 106 made of silica glass from the slot antenna 105 formed as an opening at an end of a circular waveguide 104. Due to the microwaves, a surface-wave plasma 120, which has a sheet-like shape, is generated at a surface of the dielectric window 106 made of silica glass. The plasma 120 generated at the surface of the dielectric window 106 is transferred towards the silicon wafer 110 placed on the wafer stage 111 by ambipolar diffusion. Ions in the plasma 120 are accelerated by a sheath formed at a surface of the silicon wafer 110 and penetrates the silicon wafer 110. According to this process, various treatments can be performed. The negative potential applying electrode 112 is provided between the dielectric window 106 and the slot antenna 105 formed on a slot plate.

The negative potential applying electrode 112 is electrically insulated by heat-resistant sheets made of Teflon (registered trademark), polyimide, or the like, which are disposed on an upper side and a lower side of the electrode. A DC power supply is used to apply a negative potential to the negative potential applying electrode 112. By applying an electric field to the dielectric window 106 in which the movement of Na ions is facilitated under high-temperature caused by plasma irradiation, Na ions move to a side opposite the side from which the plasma is irradiated. As a result, the amount of Na ions released from the surface of the silica glass can be reduced.

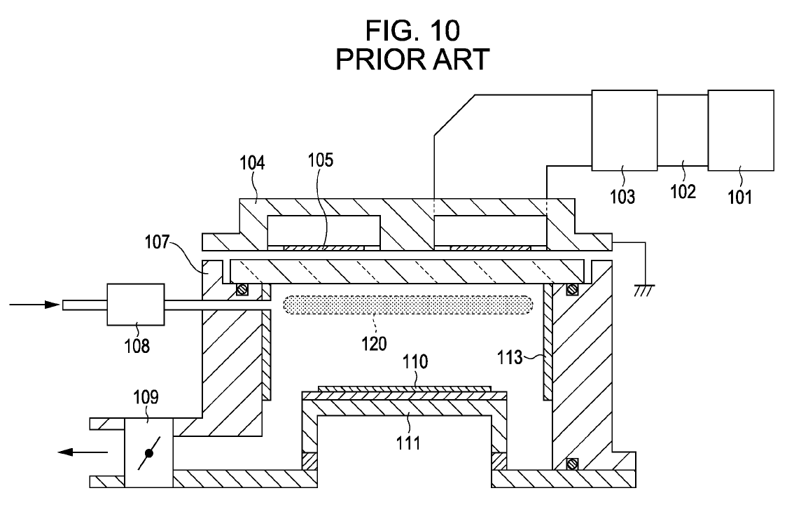

FIG. 10 is a cross-sectional view of an existing plasma treatment apparatus. A difference between the existing apparatus and the embodiment of the present invention is the presence of the negative potential applying electrode 112, which is provided between the dielectric window 106 and the slot antenna 105 formed on the slot plate, and the DC power supply connected to the negative potential applying electrode.

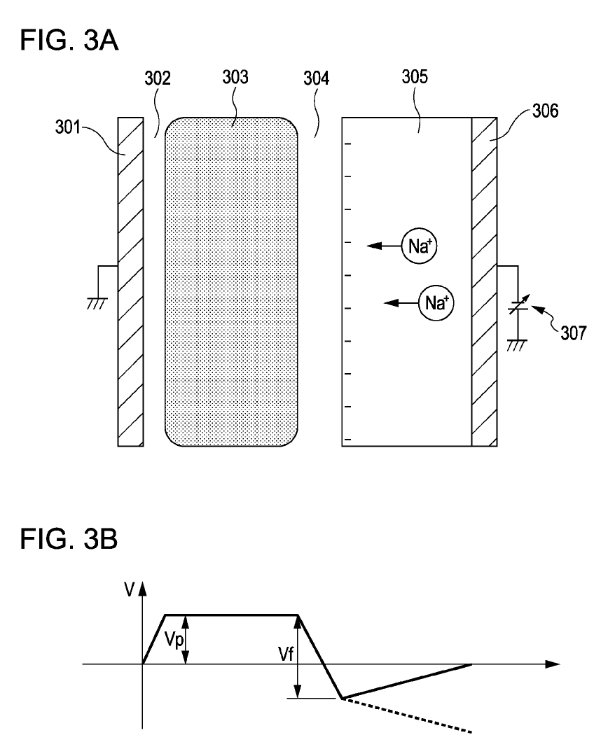

A mechanism of the movement of Na ions in a silica glass member mounted on an existing plasma treatment apparatus will be described with reference to FIGS. 3A and 3B.

FIG. 3A is a cross-sectional view of an existing plasma treatment apparatus and FIG. 3B schematically shows the electric potential of each area. The conventional plasma treatment apparatus includes a ground electrode 301, a sheath 302 of the ground electrode 301, a plasma 303, a silica glass window 305, a sheath 304 of the silica glass window 305, a negative potential applying electrode 306, and a DC power supply 307. A grounded metal member of a vacuum chamber wall exposed to the plasma serves as the ground electrode 301. In FIG. 10, the grounded metal member corresponds to a member disposed at the bottom of the vacuum chamber where the chamber is not covered with a chamber wall guard ring 113 made of silica glass. The electric potential of the ground electrode 301 is zero. The electric potential Vp of the plasma 303 can be measured using a Langmuir probe. The electric potential of the plasma 303 generated under normal conditions is about 10 V. Since the plasma 303 is an electrically conductive material, the electric potential in the plasma is constant wherever the electric potential is measured. On the other hand, the electric potential at a surface of the silica glass window, which is made of an electrically insulating material, is determined as follows. A difference in electric potential between the plasma and a floating substance in the plasma is called a sheath potential and is represented by the following,

Vp−Vf=−Te/2(1+ln(mi/2πme)) [Formula 1]

wherein, Vp is the plasma potential, Vf is the floating potential of the floating substance, Te is the electron temperature, mi is the mass of an ion, and me is the mass of an electron.

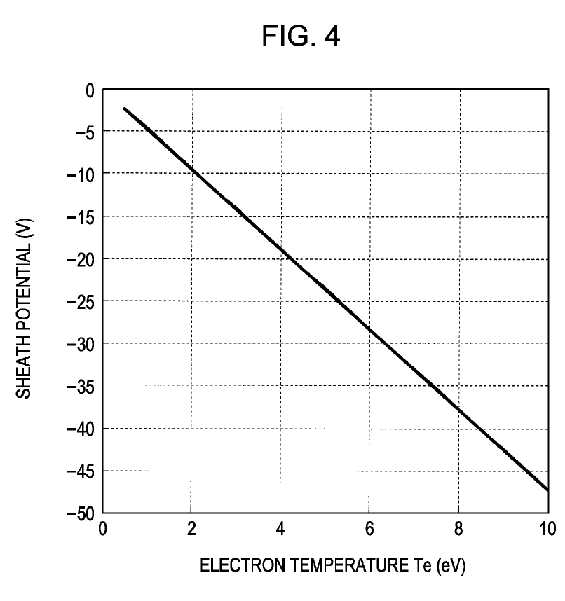

FIG. 4 shows a relationship between the electron temperature Te and the sheath potential, which is calculated using Formula 1 under the assumption that the ion is N+.

In the surface-wave interference plasma of the present embodiment, there is a large difference in electron temperature between plasma generated at the vicinity of the silica glass window and plasma diffused to the vicinity of the wafer stage. Usually in plasma, not limited to surface-wave interference plasma, the electron temperature is high in an area to which electromagnetic waves for generating plasma are irradiated with high intensity and the electron temperature is low in an area to which electromagnetic waves for generating plasma are irradiated with low intensity. As a result of measurement, it was found that while the electron temperature at the vicinity of the wafer stage was about 1.5 eV, the electron temperature at a position 2 mm away from a silica glass window was as high as about 4 eV. In the present embodiment, the electron temperature at a position within 2 mm from the window cannot be measured, the electron temperature at the surface of the window is calculated to be 5 eV or more.

It was found that the floating potential at the surface of the silica glass window was about −15 V against a ground potential because the sheath potential was about −25 V when the electron temperature was 5 eV according to FIG. 4.

On the other hand, in the existing apparatus shown in FIG. 10, a slot plate that is grounded is provided on the silica glass window at the side opposite the side exposed to the plasma. In the dielectric member, a direct electric field, the direction of which is from the slot plate to the plasma, is generated. Under the direct electric field, Na ions are forced to move in the silica glass to the side thereof that is exposed to the plasma. The temperature of the silica glass window irradiated by the plasma gradually increases. According to the measurement result, which is obtained using an infrared radiation thermometer, the temperature of the silica glass window continuously exposed to discharged plasma for 3 minutes was increased to about 500° C. when measured under ambient air. The synergy of a high temperature and an electric field mentioned above facilitates the diffusion of Na atoms. The Na atoms traveled an unexpectedly long distance in the silica glass window from the inner portion thereof to the surface portion thereof exposed to plasma. Then, the accumulated Na atoms are released into the vacuum chamber.

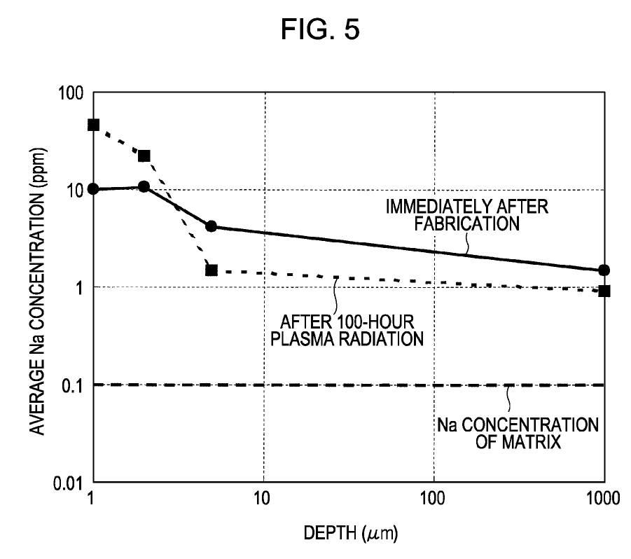

FIG. 5 is an example of the measurement results and shows the distribution of Na concentration measured in the depth direction of the silica glass member. The solid line in the graph represents the Na concentration in the silica glass member measured immediately after fabrication of the member, which is not exposed to the plasma. The Na concentration is highest at the surface and gradually decreases as the measurement depth increases. This distribution implies that Na atoms were diffused from the surface of the member into the inside of the member in a fabricating process. The dotted line in the graph represents the Na concentration in the silica glass member measured after 100-hour plasma irradiation. With plasma irradiation, the Na concentration decreases in a region having a depth of 5 μm to 1 mm and increases in a region having a depth of 5 μm or less. This result implies that, during long-term plasma irradiation, Na atoms traveled a very long distance such as several millimeters or several tens of millimeters in silica glass and accumulate at a surface of the silica glass member exposed to the plasma. As described above, a large number of Na atoms are released from the surface of the silica glass exposed to the plasma. However, the number of Na atoms released from the silica glass window exposed to the plasma can be reduced by providing an electrode on a silica glass window at a side opposite the surface exposed to the plasma and applying a lower potential than a floating potential measured at the surface of the dielectric member exposed to the plasma to the electrode.

This mechanism was verified by an experiment described as follows using an apparatus shown in FIG. 1. First, the potential of the negative potential applying electrode was set to 0 V and the discharge was performed. Then, the amount of Na adhering to a silicon wafer placed on the wafer stage was measured. The conditions of discharge were as follows:

quantity of N₂ gas flow: 1000 sccm

pressure: 133 Pa

power of microwave: 3 kW

discharge period: 12 minutes

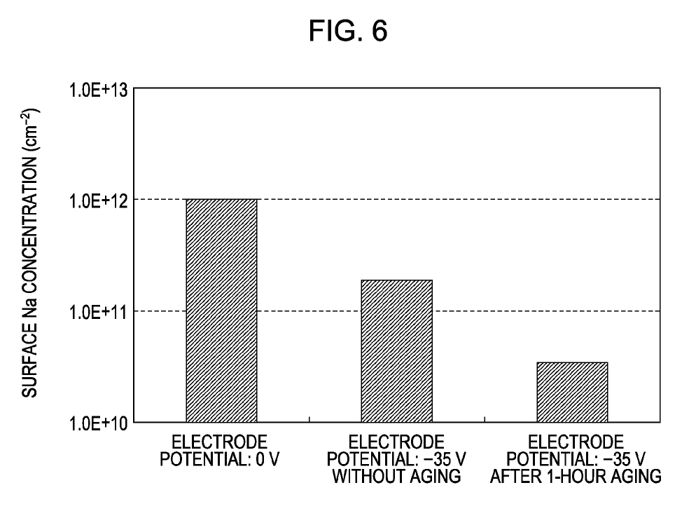

After the experiment, a similar experiment was performed in which the negative potential applying electrode was set at a potential of −35 V. Furthermore, after an aging treatment was performed under the above-mentioned conditions for 1 hour in total, the same experiment as mentioned above was conducted again under the same conditions in which the negative potential applying electrode was set at a potential of −35 V. FIG. 6 shows the results of the above-mentioned experiments. By applying an electric potential of −35 V to the negative potential applying electrode, the amount of Na adhering to the silicon wafer was decreased by almost an order of magnitude. Furthermore, by performing one-hour aging, the Na concentration was also decreased by almost an order of magnitude. In consideration of the above results, it was confirmed that the above-mentioned mechanism of releasing Na atoms is appropriate. In order to reduce the amount of Na adhering to a surface of the silicon wafer, the use of a longer aging period and a larger negative potential applied to the electrode is effective.

The effect of the present invention was described in accordance with an apparatus shown in FIG. 1. Various modifications of the negative potential applying electrode of the present invention can be provided except for the apparatus shown in FIG. 1, and in any of the modifications, the same effect as that mentioned above can be obtained.

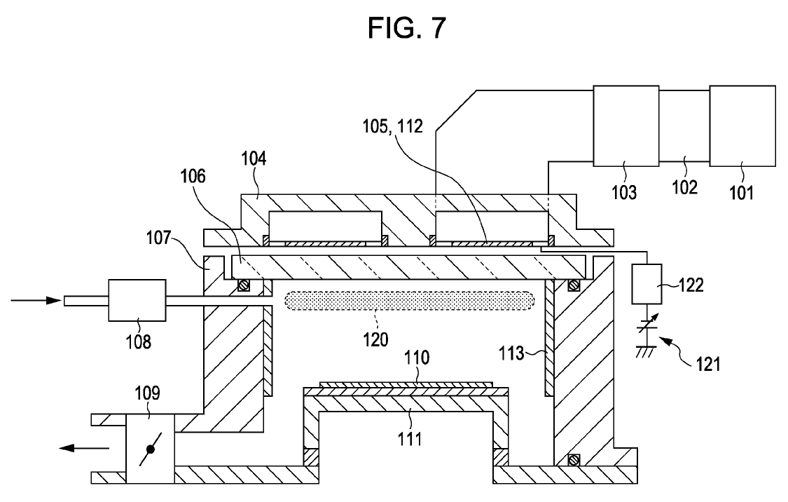

FIG. 7 shows an example in which a negative potential is applied to a slot plate. Even if a portion of a waveguide serves as the negative potential supplying electrode 112, the effect is exactly the same. In the present example, however, since high-frequency waves may be undesirably superposed on the negative potential applying electrode, a low pass filter 122 should be disposed between the negative potential supplying electrode 112 and the DC power supply 121.

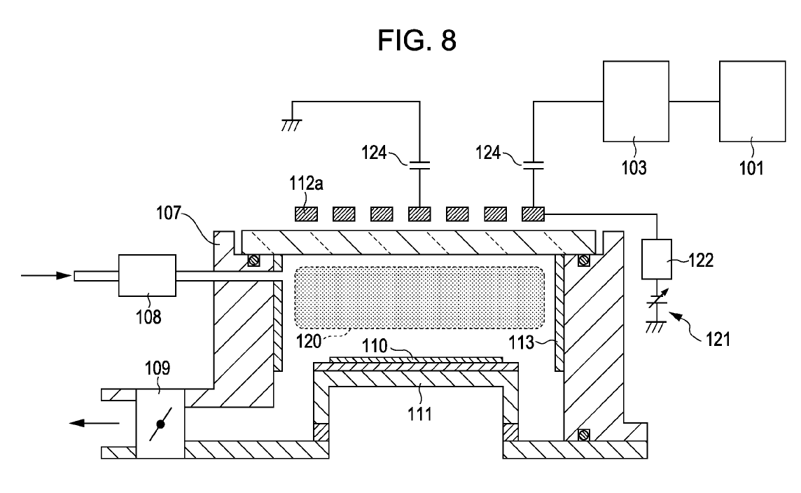

An inductive coupled plasma treatment apparatus according to an example of the present invention using a planar coil 112a serving as a negative potential applying electrode will be described with reference to FIG. 8.

FIG. 8 shows an apparatus in which a negative potential is directly applied to a high-frequency coil. The difference between this apparatus and the inductive-coupled plasma treatment apparatus mentioned as an example of an existing one is the presence of capacitors 124 serially disposed in a power supply line. In the example of existing apparatus, a terminal of the planar coil 112a opposite a terminal connected to a high-frequency power supply is always grounded. However, in the embodiment of the present invention, the average potential of the planar coil 112a is always equal to the ground potential. Thus, in order to achieve an effect of the present embodiment, the plurality of capacitors 124 may be disposed at both sides of the planar coil 112a, that is, the side of a power supply line and the side of a ground line so that the potential of the planar coil 112a can be lower than the floating potential. When a high-frequency wave is supplied, the shift of the impedance caused by insertion of the capacitors 124 into the lines can be controlled using a matching unit. Similarly to the example shown in FIG. 7, since high-frequency waves superpose on the planar coil 112a serving as the negative potential applying electrode, a low pass filter 122 should be disposed between the DC power supply 121 and the planar coil 112a serving as the negative potential applying electrode. Although FIG. 8 shows the method of superposing a negative potential directly to the planar coil 112a, the negative potential applying electrode may be additionally disposed at a position where the planar coil 112a does not exist. Furthermore, if both methods mentioned above are applied at the same time, a uniform electric field can be entirely applied over the silica glass and the reduction of Na contamination can be more effectively performed.

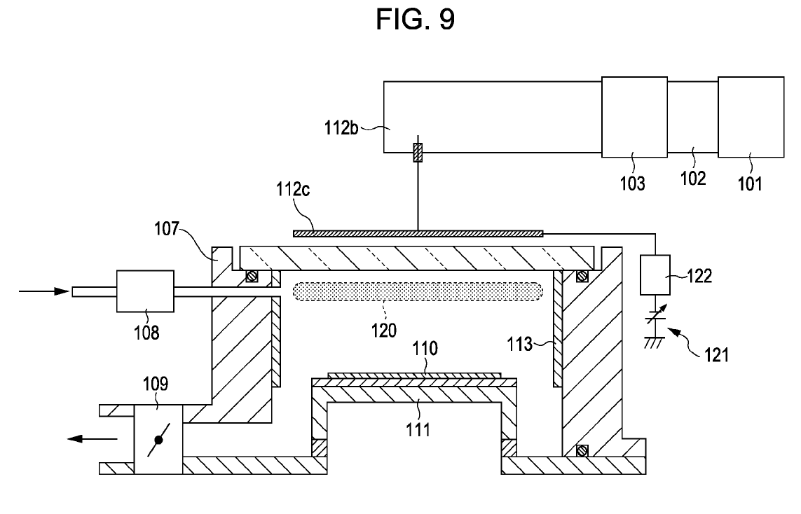

Next, with reference to FIG. 9, a plasma treatment apparatus of an embodiment of the present invention will be described, which uses a slotted plate electrode 112c serving as an electromagnetic wave radiation antenna connected to a coaxial line through a waveguide-coaxial adapter 112b.

FIG. 9 shows an apparatus in which negative potential is directly superposed on the slotted plate electrode 112c serving as the electromagnetic wave radiation antenna. In order to achieve the same effect as the above-mentioned example, the potential of the slotted plate electrode 112c serving as the electromagnetic wave radiation antenna may be lowered than the floating potential. Similarly to the example shown in FIG. 8, a low pass filter 122 should be disposed between the DC power supply 121 and the slotted plate electrode 112c serving as the negative potential applying electrode. A capacitor may be serially disposed in the coaxial line. Although FIG. 9 shows a method of directly superposing negative potential on the electromagnetic wave radiation antenna, a negative potential applying electrode may be additionally disposed between the electromagnetic wave radiation antenna and the silica glass window.

An apparatus having an electrode which is disposed near a silica glass window has been described. However, if the electrode cannot be disposed near the silica glass window, for example, in a case that the apparatus uses a cavity resonator, the potential may be applied to the cavity resonator, that is, the negative potential applying electrode may be disposed so as to be slightly separated from the silica glass window. In such a case, a large negative potential is needed compared with the case in which the electrode is disposed near the silica glass window. However, if the potential is controlled to make the electric field in the silica glass window be the same as the electric field in the electrode disposed on silica glass window, the exact same effect can be obtained.

Furthermore, the window is not limited to a silica glass window. When a sintered body made of aluminum nitride, aluminum oxide, silicon nitride, silicon carbide, or a mixture thereof is used as a window for transmitting electromagnetic waves, the same effect can be obtained as in silica glass. Although diffusion of Na ions in a bulk of the above-mentioned material is small compared with that of silica glass, Na ions can rapidly diffuse in grain boundaries having a wide gap and Li ions or hydrogen ions, which are smaller than the Na ions, can easily diffuse even in the above-mentioned materials. Therefore, from the viewpoint of prevention of diffusion of ions in the member or release of ions into a chamber, the present invention is effective.

### EXAMPLE 1

Next, EXAMPLE 1 of the present invention will be described, in which this invention is applied to a plasma nitriding process for forming a gate oxide film of a MOS capacitor. The initial thickness of the oxide film was 1.5 nm and the surface-wave interference plasma treatment apparatus of the present invention shown in FIG. 1 was used.

First, a silicon wafer was placed on a wafer stage kept at a temperature of 300° C. and a vacuum chamber was evacuated by an oil-less pump (not shown in drawings) to a pressure of 1 Pa. Next, N₂ gas was introduced into the vacuum chamber at a flow rate of 1000 sccm and the pressure in the vacuum chamber was set to 133 Pa. Then, plasma was generated by applying a high-frequency power of 1500 W. This plasma treatment was continuously conducted for 180 seconds. Two samples were fabricated under the conditions that a voltage of 0 V or −50 V was applied to the negative potential applying electrode while plasma was discharged. Then, a gate electrode was formed on each of the samples and MOS capacitor properties of the samples were measured. According to the comparison results, the gate leak current density Jg (Vg=1.0 V) of the sample, fabricated under a condition in which the voltage applied to the negative potential applying electrode was 0 V, was 1.0 A/cm². On the other hand, the gate leak current density of the sample of the present EXAMPLE, which was fabricated under a condition in which the voltage applied to the negative potential applying electrode was −50 V, was 0.6 A/cm². This decrease in the current density may have occurred because the amount of Na incorporated into the gate oxide film during plasma treatment was low. As mentioned above, it is confirmed that the present invention is effective when a silicon oxide film serving as a gate dielectric film is nitrided by plasma.

### EXAMPLE 2

Next, EXAMPLE 2 of the present invention will be described, in which this invention is applied to a plasma oxiding process for forming a gate oxide film of a MOS capacitor.

The surface-wave interference plasma treatment apparatus shown in FIG. 1 was used as a plasma treatment apparatus. First, a silicon wafer, which was cleaned with hydrofluoric acid, was placed on a wafer stage kept at a temperature of 300° C. and a vacuum chamber was evacuated by an oil-less pump (not shown in drawings) to a pressure of 1 Pa. Next, O₂ gas was introduced into the vacuum chamber at a flow rate of 1000 sccm and the pressure in the vacuum chamber was set to 133 Pa. Then, plasma was generated by applying a high-frequency power of 1300 W. This plasma treatment was continuously conducted for 30 seconds. As the result of measurement conducted after the treatment, the thickness of the oxide film formed by the plasma treatment was 2.5 nm.

Next, a plasma nitridation was performed under the same condition as EXAMPLE 1. Two samples were fabricated under the conditions that a voltage of 0 V or −50 V was applied to the negative potential applying electrode while oxidation and nitridation were performed. Then, a gate electrode was formed on each of the samples and MOS capacitor properties of the samples were measured. According to the comparison results, the gate leak current density Jg (Vg=1.0 V) of the sample, fabricated under a condition in which the voltage applied to the negative potential applying electrode was 0 V, was 5×10⁻⁵ A/cm². On the other hand, the gate leak current density of the sample of the present EXAMPLE, which was fabricated under a condition in which the voltage applied to the negative potential applying electrode was −50 V, was 1×10⁻⁵ A/cm². This decrease in the current density may have occurred because the amount of Na incorporated into the gate oxide film during plasma treatment was low. As mentioned above, it is confirmed that the present invention is effective when a silicon oxide film serving as a gate dielectric film is formed by plasma oxidating and then plasma nitriding.

### EXAMPLE 3

Next, EXAMPLE 3 of the present invention will be described, in which the planar coil inductive coupled plasma treatment apparatus shown in FIG. 8 was used and this invention is applied to a plasma oxiding process for forming a gate oxide film of a MOS capacitor.

First, a silicon wafer, which was cleaned with hydrofluoric acid, was placed on a wafer stage kept at a temperature of 300° C. and a vacuum chamber was evacuated by an oil-less pump (not shown in drawings) to a pressure of 1 Pa. Next, O₂ gas was introduced into the vacuum chamber at a flow rate of 500 sccm and the pressure in the vacuum chamber was set to 66.5 Pa. Then, plasma was generated by applying a high-frequency power of 2000 W. This plasma treatment was continuously conducted for 180 seconds. As the result of measurement conducted after the treatment, the thickness of the oxide film formed by the plasma treatment was 2.8 nm. Next, a plasma nitridation was performed using the apparatus shown in FIG. 8 under the conditions at a flow rate of N₂ gas was 500 sccm, a pressure in the chamber was 66.5 Pa, and the applied high frequency power was 2000 W. This plasma treatment was continuously conducted for 180 seconds. Two samples were fabricated under the conditions that a voltage of 0 V or −50 V was applied to the negative potential applying electrode while oxidation and nitridation were performed. Then, a gate electrode was formed on each of the samples and MOS capacitor properties of the samples were measured. According to the comparison results, the gate leak current density Jg (Vg=1.0 V) of the sample, fabricated under a condition in which the voltage applied to the negative potential applying electrode was 0 V, was 2×10⁻⁵ A/cm². On the other hand, the gate leak current density of the sample of the present EXAMPLE, which was fabricated under a condition in which the voltage applied to the negative potential applying electrode was −50 V, was 8×10⁻⁶ A/cm². This decrease in the current density may have occurred because the amount of Na incorporated into the gate oxide film during plasma treatment was low. As mentioned above, it is confirmed that the present invention is effective when applied to the planar coil inductive coupled plasma treatment apparatus.

### EXAMPLE 4

Next, EXAMPLE 4 of the present invention will be described, in which the plasma treatment apparatus having an electromagnetic radiation antenna connected with a coaxial line, which is shown in FIG. 9, was used and this invention is applied to a plasma oxiding process for forming a gate oxide film of a MOS capacitor.

First, a silicon wafer, which was cleaned with hydrofluoric acid, was placed on a wafer stage kept at a temperature of 300° C. and a vacuum chamber was evacuated by an oil-less pump (not shown in drawings) to a pressure of 1 Pa. Next, O₂ gas was introduced into the vacuum chamber at a flow rate of 500 sccm and the pressure in the vacuum chamber was set to 66.5 Pa. Then, plasma was generated by applying a high-frequency power of 1000 W. This plasma treatment was continuously conducted for 300 seconds. As the result of measurement conducted after the treatment, the thickness of the oxide film formed by the plasma treatment was 2.5 nm.

Next, a plasma nitridation was performed using the plasma treatment apparatus shown in FIG. 9 under the conditions at a flow rate of N₂ gas was 500 sccm, a pressure in the chamber was 66.5 Pa, and the applied high frequency power was 1000 W. This plasma treatment was continuously conducted for 180 seconds. Two samples were fabricated under the conditions that a voltage of 0 V or −50 V was applied to the negative potential applying electrode while oxidation and nitridation were performed. Then, a gate electrode was formed on each of the samples and MOS capacitor properties of the samples were measured. According to the comparison results, the gate leak current density Jg (Vg=1.0 V) of the sample, fabricated under a condition in which the voltage applied to the negative potential applying electrode was 0 V, was 6×10⁻⁵ A/cm². On the other hand, the gate leak current density of the sample of the present EXAMPLE, which was fabricated under a condition in which the voltage applied to the negative potential applying electrode was −50 V, was 2.5×10⁻⁵ A/cm². This decrease in the current density may have occurred because the amount of Na incorporated into the gate oxide film during plasma treatment was low. As mentioned above, it is confirmed that the present invention is effective when applied to the plasma treatment apparatus having an electromagnetic radiation antenna connected to a coaxial line.

### EXAMPLE 5

Next, EXAMPLE 5 of the present invention will be described, in which this invention is applied to a plasma oxiding process for forming a thick oxide film of a CCD device or a flash memory. The surface-wave interference plasma treatment apparatus shown in FIG. 1 was used as a plasma treatment apparatus. First, a silicon wafer, which was cleaned with hydrofluoric acid, was placed on a wafer stage kept at a temperature of 300° C. and a vacuum chamber was evacuated by an oil-less pump (not shown in drawings) to a pressure of 1 Pa. Next, O₂ gas was introduced into the vacuum chamber at a flow rate of 1000 sccm and the pressure in the vacuum chamber was set to 133 Pa. Then, plasma was generated by applying a high-frequency power of 3000 W. This plasma treatment was continuously conducted for 300 seconds. As the result of measurement conducted after the treatment, the thickness of the oxide film formed by the plasma treatment was 10 nm. Two samples were fabricated under the conditions that a voltage of 0 V or −50 V was applied to the negative potential applying electrode while oxidation was performed. Then, Na concentration on the wafer surface was measured by inductively coupled plasma-mass spectroscopy (ICP-MS). According to the comparison results, the Na concentration of the sample at the surface thereof, fabricated under a condition in which the voltage applied to the negative potential applying electrode was 0 V, was 3×10¹² atoms/cm². On the other hand, the Na concentration of the sample at the surface thereof of the present EXAMPLE, which was fabricated under a condition in which the voltage applied to the negative potential applying electrode was −50 V, was 1×10¹⁰ atoms/cm² or less. As mentioned above, it is found that if the present invention is used in a long-term plasma treatment, Na concentration can be largely decreased.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2007-131088, filed May 16, 2007, which is hereby incorporated by reference herein in its entirety.

What is claimed is:

1. A plasma treatment apparatus configured to generate plasma in a vacuum chamber and treat a workpiece with the generated plasma, the apparatus comprising:
a dielectric member including an impurity element forming positive and movable ions;
a vacuum chamber partially sealed with the dielectric member;
a pressure controller configured to introduce gas into the vacuum chamber and control a pressure in the vacuum chamber;
an electromagnetic wave radiator configured to radiate electromagnetic waves into the vacuum chamber through the dielectric member;
a holder holding a workpiece;
an electrode provided on the dielectric member at a surface opposite the surface exposed to the plasma; and
a DC potential applier configured to apply to the electrode a negative DC potential being lower than a floating potential at the surface of the dielectric member exposed to the plasma.

2. The plasma treatment apparatus according to the claim 1, wherein the impurity element is an alkali metal, an alkaline-earth metal, or hydrogen.

3. The plasma treatment apparatus according to the claim 1, wherein the dielectric member is a sintered body made of silica glass, aluminum nitride, aluminum oxide, silicon nitride, silicon carbide, or a mixture thereof.

4. The plasma treatment apparatus according to the claim 1, wherein the negative DC potential is a potential in which high frequency waves are superposed and is negative in time average.

5. The plasma treatment apparatus according to the claim 1, wherein the electromagnetic wave radiator forms an induced electromagnetic field using a coil or an electromagnetic induction.

6. The plasma treatment apparatus according to the claim 1, wherein an opening formed on a face of a waveguide or a cavity resonator serves as the electromagnetic wave radiator.

7. The plasma treatment apparatus according to the claim 1, wherein the electromagnetic wave radiator is an electromagnetic radiation plate connected with a coaxial line.

8. The plasma treatment apparatus according to the claim 1, wherein the electrode to which the negative DC potential is applied serves as the electromagnetic wave radiator radiating the electromagnetic wave into the vacuum chamber.

9. The plasma treatment apparatus according to the claim 1, wherein the electrode to which the negative DC potential is applied is provided separately from the electromagnetic wave radiator radiating electromagnetic wave into the vacuum chamber.

10. A plasma treatment method which utilizes a plasma treatment apparatus configured to generate plasma in a vacuum chamber and treat a workpiece with the generated plasma, the apparatus including,
a dielectric member including an impurity element forming positive and movable ions;
a vacuum chamber partially sealed with the dielectric member;
a pressure controller configured to introduce gas into the vacuum chamber and control a pressure in the vacuum chamber;
an electromagnetic wave radiator configured to radiating electromagnetic waves into the vacuum chamber through the dielectric member;
a holder holding a workpiece;
an electrode provided on the dielectric member at a surface opposite the surface exposed to the plasma; and
a DC potential applier configured to apply to the electrode a negative DC potential being lower than a floating potential at the surface of the dielectric member exposed to the plasma; the method comprising:
generating plasma in the vacuum chamber and treating the workpiece with the plasma using the plasma treatment apparatus,
wherein a negative DC potential is applied to the electrode provided on the dielectric member at a surface opposite the surface exposed to the plasma, the negative DC potential being lower than a floating potential at the surface of the dielectric member exposed to the plasma.
